(19) United States
(12) Patent Application Publication
(10) Pub. No.: US 2025/0346758 A1
(43) Pub. Date: Nov. 13, 2025

(54) RESIN COMPOSITION

(71) Applicant: NAN YA PLASTICS CORPORATION, Taipei City (TW)

(72) Inventors: Ching-Yao Yuan, Taipei City (TW); Yi-Je Tsai, Taipei City (TW); Li Yun Chen, Taipei City (TW); Hung-Yi Chang, Taipei City (TW); Chia-Lin Liu, Taipei City (TW)

(73) Assignee: NAN YA PLASTICS CORPORATION, Taipei City (TW)

(21) Appl. No.: 18/676,480

(22) Filed: May 28, 2024

(30) Foreign Application Priority Data
May 8, 2024 (TW) 113116984

(51) Int. Cl. C08L 71/12

(52) U.S. Cl. CPC C08L 71/126; C08L 71/123; C08L 2205/025; C08L 2205/035

(57) ABSTRACT

A resin composition includes base resin and hardened resin. The base resin includes polyphenylene ether resin, a vinyl copolymer, and an olefin compound. A weight proportion of the base resin in the resin composition is between 15 wt % and 20 wt %. The hardened resin includes cyclopentadiene-styrene copolymer resin, triallyl isocyanurate, and maleimide resin. A weight proportion of the hardened resin in the resin composition is between 10 wt % and 15 wt %.

### CROSS-REFERENCE TO RELATED APPLICATION

This application claims the priority benefit of Taiwan application serial no. 113116984, filed on May 8, 2024. The entirety of the above-mentioned patent application is hereby incorporated by reference herein and made a part of specification.

### BACKGROUND

### Technical Field

The disclosure relates to a resin composition.

### Description of Related Art

In recent years, with the rapid development of integrated circuit (IC) technology, the requirements for the wiring density (L/S) and transmission rate of chips (e.g., high-speed computing chips) have increased. Moreover, in order to be more suitable for applications in the high-frequency fast transmission fields, the requirements for low dielectric properties of resin compositions are also increasing.

### SUMMARY

The disclosure provides a resin composition exhibiting good performance in terms of roughness, peel strength, and electrical properties.

The disclosure provides a resin composition including base resin and hardened resin. The base resin includes polyphenylene ether resin, a vinyl copolymer, and an olefin compound. A weight proportion of the base resin in the resin composition is between 15 wt % and 20 wt %. The hardened resin includes cyclopentadiene-styrene copolymer resin, triallyl isocyanurate, and maleimide resin. A weight proportion of the hardened resin in the resin composition is between 10 wt % and 15 wt %.

In an embodiment of the disclosure, the olefin compound includes hydrocarbon resin, a hydrogenated styrenic elastomer, a modified styrenic elastomer with an acid anhydride group, a vinyl-containing aromatic alicyclic copolymer, allylated phenol resin (LVA01), or a combination thereof.

In an embodiment of the disclosure, a weight proportion of the polyphenylene ether resin in the base resin is between 65 wt % and 75 wt %. A weight proportion of the vinyl copolymer in the base resin is between 10 wt % and 15 wt %. A weight proportion of the olefin compound in the base resin is between 15 wt % and 20 wt %.

In an embodiment of the disclosure, the resin composition further includes an initiator. A weight proportion of the initiator in the resin composition is between 0.1 wt % and 0.2 wt %.

In an embodiment of the disclosure, the resin composition further includes an inorganic filler material. A weight proportion of the inorganic filler material in the resin composition is between 60 wt % and 80 wt %.

In an embodiment of the disclosure, a content of the polyphenylene ether resin in the base resin is greater than a content of the olefin compound in the base resin.

In an embodiment of the disclosure, a content of the polyphenylene ether resin in the base resin is greater than a content of the vinyl copolymer in the base resin.

In an embodiment of the disclosure, a content of the base resin in the resin composition in greater than a content of the hardened resin in the resin composition.

In an embodiment of the disclosure, a content of the cyclopentadiene-styrene copolymer resin in the hardened resin is greater than a content of the triallyl isocyanurate in the hardened resin and a content of the maleimide resin in the hardened resin.

In an embodiment of the disclosure, a content of the maleimide resin in the hardened resin is greater than a content of the triallyl isocyanurate in the hardened resin.

To sum up, in the disclosure, by introducing the olefin compound into the resin system of the polyphenylene ether resin and the vinyl copolymer and through the combination of the cyclopentadiene-styrene copolymer resin, the triallyl isocyanurate, and the maleimide resin, the resin composition exhibits good performance in terms of roughness, peel strength, and electrical properties.

To make the aforementioned more comprehensible, several embodiments are described in detail as follows.

### DESCRIPTION OF THE EMBODIMENTS

In the following detailed description, for the purposes of illustration and not limitation, example embodiments disclosing specific details are set forth in order to provide a thorough understanding of the various principles of the disclosure. However, it will be apparent to a person having ordinary skill in the art, having the benefit of this disclosure, that the disclosure may be practiced in other embodiments that depart from the specific details disclosed herein.

Unless otherwise stated, the term “between” used in defining numerical ranges in this specification is intended to encompass a range equal to and between the stated endpoint values. For instance, the size range is between the first value and the second value, which means that the size range can cover the first value, the second value, and any value between the first value and the second value.

Unless otherwise defined, all terms (including technical and scientific terms) used herein have the same meaning as commonly understood by a person having ordinary skill in the art.

In this embodiment, a resin composition includes base resin and hardened resin (may be treated as a hardener). A weight proportion of the base resin in the resin composition is between 15 wt % and 20 wt %, and a weight proportion of the hardened resin in the resin composition is between 10 wt % and 15 wt %. Further, the base resin includes polyphenylene ether resin, a vinyl copolymer, and an olefin compound. The hardened resin includes cyclopentadiene-styrene copolymer resin, triallyl isocyanurate, and maleimide resin. Accordingly, in this embodiment, by introducing the olefin compound into a resin system of the polyphenylene ether resin and the vinyl copolymer and through the combination of the cyclopentadiene-styrene copolymer resin, the triallyl isocyanurate, and the maleimide resin, the resin composition may exhibit good performance in terms of roughness, peel strength, and electrical properties.

In some embodiments, the olefin compound includes hydrocarbon resin, a hydrogenated styrenic elastomer, a modified styrenic elastomer with an acid anhydride group, a vinyl-containing aromatic alicyclic copolymer, allylated phenol resin ((LVA01), or a combination thereof to exhibit good combining properties, but the disclosure is not limited thereto.

In some embodiments, a weight proportion of the polyphenylene ether resin in the base resin is between 65 wt % and 75 wt %. A weight proportion of the vinyl copolymer in the base resin is between 10 wt % and 15 wt %. A weight proportion of the olefin compound in the base resin is between 15 wt % and 20 wt %. However, the disclosure is not limited thereto.

In some embodiments, a content of the polyphenylene ether resin in the base resin is greater than a content of the olefin compound in the base resin, and/or the content of the polyphenylene ether resin in the base resin is greater than a content of the vinyl copolymer in the base resin to exhibit good electrical performance, but the disclosure is not limited thereto.

In some embodiments, a sum of the weight proportion of the polyphenylene ether resin in the base resin, the weight proportion of the vinyl copolymer in the base resin, and the weight proportion of the olefin compound in the base resin is 100 wt %. That is, the base resin includes only the polyphenylene ether resin, the vinyl copolymer, and the olefin compound, but the disclosure is not limited thereto.

In some embodiments, a content of the base resin in the resin composition in greater than a content of the hardened resin in the resin composition, but the disclosure is not limited thereto.

In some embodiments, a content of the cyclopentadiene-styrene copolymer resin in the hardened resin is greater than a content of the triallyl isocyanurate in the hardened resin and a content of the maleimide resin in the hardened resin, but the disclosure is not limited thereto.

In some embodiments, the content of the maleimide resin in the hardened resin is greater than the content of the triallyl isocyanurate in the hardened resin, but the disclosure is not limited thereto.

In some embodiments, the resin composition further includes an initiator, and a weight proportion of the initiator in the resin composition is between 0.1 wt % and 0.2 wt %. For instance, the initiator includes 1,3-bis(butylperoxyisopropyl)benzene, but the disclosure is not limited thereto, and may also be other suitable peroxides.

In some embodiments, the resin composition further includes an inorganic filler material, and a weight proportion of the inorganic filler material in the resin composition is between 60 wt % and 80 wt %. For instance, the inorganic filler material includes silicon oxide, but the disclosure is not limited thereto, and may also be other suitable fillers.

It should be noted that the resin composition may be treated as a non-volatile component of a resin composition (varnish form) dissolved in a solvent. When the non-volatile component is taken as 100 wt %, the content of the inorganic filler material is greater than or equal to 70 wt %, but the disclosure is not limited thereto. In addition, the resin composition of the disclosure may be processed into a prepreg and a copper clad laminate (CCL) according to actual design needs, and the specific implementation examples listed above are not limitations of the disclosure.

The following Examples and Comparative Example are given to illustrate the effects of the disclosure, but the scope of the disclosure is not limited to the scope of the examples.

The products of each Example and Comparative Example are evaluated according to the following method.

Dielectric constant Dk and dissipation factor Df: The abovementioned resin film was heated at 200° C. for 90 minutes to form a cured film. The cured film was cut into a length of 10 mm and a width of 7 mm. According to the standard test method of IPC-TM-650 (Method 2.5.5.3), the dielectric constant (Dk, ε r) and the dissipation factor (Df, Tan δ) of the material under a 10 GHz signal were measured.

Coefficient of thermal expansion (CTE) (x-y plane direction): According to the standard test method of IPC-TM-650 2.4.24., a thermomechanical analyzer (TMA) was used to measure the coefficient of thermal expansion of the X-Y plane, i.e., X-Y CTE (ppm/° C.), of the material. The temperature rising range condition of the test was 40° C. to 120° C.

Coefficient of thermal expansion (CTE) (z plane direction): According to the standard test method of IPC-TM-650 2.4.24., a thermomechanical analyzer (TMA) was used to measure the coefficient of thermal expansion of the Z plane, i.e., Z CTE (ppm/° C.), of the material. The temperature rising range condition of the test was 50° C. to 260° C.

Glass transition temperature (Tg) (° C.): According to the standard test method of ASTM E1545, a thermomechanical analyzer (TMA) was used to measure the glass transition temperature Tg (° C.) of the material.

Resin sheet lamination and curing: A glass cloth epoxy resin base material with copper foil was prepared as an inner substrate, and both sides were covered with a copper laminate (“NPG-180INBK” manufactured by Nanya Corporation), and the surface copper foil of the inner substrate was roughened. A vacuum laminator (“V-130” manufactured by Nikko-Materials Co., Ltd.) was used, and the resin composition and the abovementioned inner layer substrate were bonded through the vacuum laminator under the following conditions: after the pressure was reduced to less than 1 hPa for 30 seconds, lamination was performed for 60 seconds at a temperature of 100° C./pressure of 100N. After that, it was heated in an oven at 130° C. for 30 minutes and then moved to an oven at 165° C. for 30 minutes. The resin composition was cured by the abovementioned heating, and an “evaluation substrate A” was obtained.

Desmear treatment: In order to roughen the cured resin sheet substrate, the evaluation substrate A was immersed in Sweller 7810 manufactured by DuPont at 70° C. for 10 minutes. Next, the substrate was immersed in Promotor 7820 manufactured by DuPont at 85° C. for 10 minutes. Finally, the substrate was immersed in Neutralizer 7831 manufactured by DuPont at 40° C. for 5 minutes, and an “evaluation substrate B” after the desmear treatment was obtained.

Formation of the plated conductor layer: A copper plated layer (second conductor layer) was formed on a surface of the evaluation substrate B. The evaluation substrate B was immersed in an electroless plating solution containing PdCl₂ at 40° C. for 5 minutes and then in an electroless copper plating solution at 25° C. for 20 minutes. The obtained evaluation substrate B was annealed by heating at 150° C. for 30 minutes, and then copper sulfate electrolytic plating was performed to form a copper plating layer with a thickness of 30 μm. The evaluation substrate B on which the copper plating layer was formed was annealed at 190° C. for 60 minutes. The obtained substrate was called “evaluation substrate C”.

Roughness Ra (nm): A laser conjugate focus microscope (“VK-X3000” manufactured by Keyence Corporation) was used to measure the evaluation substrate B under a 50× lens, and 10 points were randomly selected to measure the arithmetic mean roughness Ra.

Peel strength (lbf/in): A cutout of a 10 mm wide and 100 mm long portion was made in the copper plating layer of the evaluation substrate C, and one end was peeled off and clamped with a clamp. A tensile testing machine (“AC-50C-SL” manufactured by TSE Co., Ltd.) was used to measure the load when peeling 35 mm in the vertical direction at a speed of 50 mm/min at room temperature (25° C.).

### Examples 1 to 5 and Comparative Example 1

The resin composition shown in Table 1 was dissolved in a solvent (toluene) to form a liquid resin composition (varnish form)), was then coated on a support (PET release film) using a die coater, and dried to form a film layer. After that, its dielectric constant, dissipation factor, coefficient of thermal expansion, glass transition temperature, peel strength, chemical resistance, and other properties were evaluated. The results are shown in Table 1. After the results of Examples 1 to 5 and Comparative Example 1 in Table 1 are compared, the following conclusions can be drawn. In the resin compositions of Example 1 to Example 5, by introducing the olefin compound into the resin system of the polyphenylene ether resin and the vinyl copolymer and through the combination of the cyclopentadiene-styrene copolymer resin, the triallyl isocyanurate, and the maleimide resin, the resin compositions exhibit good performance in terms of roughness, peel strength, and electrical properties. For instance, the dielectric constant (Dk) of the preferred Example 1 can reach 2.98, and the dissipation factor (Df) can reach 0.0016.

TABLE 1

| | | | | | | | Comparative |
|---|---|---|---|---|---|---|---|
| | | Example | | | | | Example |
| | | 1 | 2 | 3 | 4 | 5 | 1 |
| Base Resin | olefin compound | 2.98 | 0 | 0 | 0 | 0 | 0 |
| | (hydrocarbon resin, | | | | | | |
| | LDM-03) | | | | | | |
| | olefin compound | 0 | 2.98 | 0 | 0 | 0 | 0 |
| | (hydrogenated styrenic | | | | | | |
| | elastomer, MP10) | | | | | | |
| | olefin compound | 0 | 0 | 2.98 | 0 | 0 | 0 |
| | (modified styrenic | | | | | | |
| | elastomer with an | | | | | | |
| | anhydride group, | | | | | | |
| | M1913) | | | | | | |
| | olefin compound (vinyl- | 0 | 0 | 0 | 2.98 | 0 | 0 |
| | containing aromatic | | | | | | |
| | alicyclic copolymer, | | | | | | |
| | B2000) | | | | | | |
| | olefin compound | 0 | 0 | 0 | 0 | 2.98 | 0 |
| | (LVA01) | | | | | | |
| | polyphenylene ether | 6.27 | 6.27 | 6.27 | 6.27 | 6.27 | 7.76 |
| | resin (methacrylate | | | | | | |
| | polyphenylene ether | | | | | | |
| | resin, SA9000) (parts by | | | | | | |
| | weight) | | | | | | |
| | polyphenylene ether | 6.27 | 6.27 | 6.27 | 6.27 | 6.27 | 7.76 |
| | resin (oligophenylene | | | | | | |
| | ether, OPE1200) (parts | | | | | | |
| | by weight) | | | | | | |
| | vinyl copolymer | 2.09 | 2.09 | 2.09 | 2.09 | 2.09 | 2.09 |
| | (butadiene-styrene | | | | | | |
| | copolymer, S1605) (parts | | | | | | |
| | by weight) | | | | | | |
| Hardened | cyclopentadiene-styrene | 5.37 | 5.37 | 5.37 | 5.37 | 5.37 | 5.37 |
| Resin | copolymer resin | | | | | | |
| | (SLK250) (parts by | | | | | | |
| | weight) | | | | | | |
| | triallyl isocyanurate | 2.39 | 2.39 | 2.39 | 2.39 | 2.39 | 2.39 |
| | (TAIC) (parts by weight) | | | | | | |
| | maleimide resin (DIC | 4.48 | 4.48 | 4.48 | 4.48 | 4.48 | 4.48 |
| | NE-X9470S) (parts by | | | | | | |
| | weight) | | | | | | |
| | initiator (1,3- | 0.15 | 0.15 | 0.15 | 0.15 | 0.15 | 0.15 |
| | bis(butylperoxyisopropyl) | | | | | | |
| | benzene, Perbutyl P) | | | | | | |
| | inorganic filler material | 70 | 70 | 70 | 70 | 70 | 70 |
| | (silicon oxide, SC2300- | | | | | | |
| | SVJ) | | | | | | |

| | | | | | | |
|---|---|---|---|---|---|---|
| Electrical properties (Dk/Df) (10 GHz) | 2.98/0.0016 | 3.04/0.0018 | 3.07/0.0017 | 2.96/0.0018 | 2.92/0.0018 | 3.02/0.0019 |
| Electrical properties (Dk/Df) (28 GHz) | 3.09/0.0019 | 3.27/0.0019 | 3.15/0.0018 | 3.04/0.0022 | 3.17/0.0019 | 3.17/0.0019 |
| X-Y coefficient of thermal expansion | 25.1 | 28.0 | 24.1 | 20.6 | 18.2 | 20.3 |
| (40° C. to 120° C.) (ppm/° C.) | | | | | | |
| Z coefficient of thermal expansion | 0.69 | 0.89 | 0.64 | 0.55 | 0.43 | 0.56 |
| (50° C. to 260° C.) (ppm/° C.) | | | | | | |
| Glass transition temperature (° C.) | 245 | 226 | 189 | 210 | 211 | 254 |
| Roughness Ra (nm) | 171 | 165 | 167 | 173 | 159 | 323 |
| Peel strength (lbf/in) | 2.89 | 2.71 | 2.66 | 2.49 | 2.57 | 1.13 |

In view of the foregoing, in the disclosure, by introducing the olefin compound into a resin system of the polyphenylene ether resin and the vinyl copolymer and through the combination of the cyclopentadiene-styrene copolymer resin, the triallyl isocyanurate, and the maleimide resin, the resin composition may exhibit good performance in terms of roughness, peel strength, and electrical properties.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A resin composition, comprising:
base resin comprising polyphenylene ether resin, a vinyl copolymer, and an olefin compound, wherein a weight proportion of the base resin in the resin composition is between 15 wt % and 20 wt %; and
hardened resin comprising cyclopentadiene-styrene copolymer resin, triallyl isocyanurate, and maleimide resin, wherein a weight proportion of the hardened resin in the resin composition is between 10 wt % and 15 wt %.

2. The resin composition according to claim 1, wherein the olefin compound comprises hydrocarbon resin, a hydrogenated styrenic elastomer, a modified styrenic elastomer with an acid anhydride group, a vinyl-containing aromatic alicyclic copolymer, allylated phenol resin, or a combination thereof.

3. The resin composition according to claim 1, wherein a weight proportion of the polyphenylene ether resin in the base resin is between 65 wt % and 75 wt %, a weight proportion of the vinyl copolymer in the base resin is between 10 wt % and 15 wt %, and a weight proportion of the olefin compound in the base resin is between 15 wt % and 20 wt %.

4. The resin composition according to claim 1, further comprising an initiator, wherein a weight proportion of the initiator in the resin composition is between 0.1 wt % and 0.2 wt %.

5. The resin composition according to claim 1, further comprising an inorganic filler material, wherein a weight proportion of the inorganic filler material in the resin composition is between 60 wt % and 80 wt %.

6. The resin composition according to claim 1, wherein a content of the polyphenylene ether resin in the base resin is greater than a content of the olefin compound in the base resin.

7. The resin composition according to claim 1, wherein a content of the polyphenylene ether resin in the base resin is greater than a content of the vinyl copolymer in the base resin.

8. The resin composition according to claim 1, wherein a content of the base resin in the resin composition in greater than a content of the hardened resin in the resin composition.

9. The resin composition according to claim 1, wherein a content of the cyclopentadiene-styrene copolymer resin in the hardened resin is greater than a content of the triallyl isocyanurate in the hardened resin and a content of the maleimide resin in the hardened resin.

10. The resin composition according to claim 1, wherein a content of the maleimide resin in the hardened resin is greater than a content of the triallyl isocyanurate in the hardened resin.
